(19) United States
(12) Patent Application Publication
(10) Pub. No.: US 2026/0015258 A1
(43) Pub. Date: Jan. 15, 2026

(54) METHOD, APPARATUS AND SYSTEM FOR REMOVAL OF PFAS FROM AN AQUEOUS SOURCE AND PRODUCTION OF CONCENTRATED PFAS PRODUCT

(71) Applicant: TREATA ENVIRONMENTAL PTY LTD, Balwyn North, Victoria (AU)

(72) Inventors: Victor Rudolph, Balwyn North, Victoria (AU); Pradeep R. Shukla, Balwyn North, Victoria (AU)

(21) Appl. No.: 18/994,682

(22) PCT Filed: Jul. 19, 2023
(86) PCT No.: PCT/AU2023/050662

§ 371 Date: Jan. 15, 2025

(30) Foreign Application Priority Data
Jul. 19, 2022 (AU) 2022902018
Jun. 28, 2023 (AU) 2023902057

(51) Int. Cl. C02F 1/24; C02F 1/26; C02F 101/30; C02F 101/36

(52) U.S. Cl. CPC C02F 1/24; C02F 1/26; C02F 2101/301; C02F 2101/36; C02F 2201/005; C02F 2209/40; C02F 2301/08

(57) ABSTRACT

A method for recovering a chemical substance from an aqueous body is described. The method comprises producing a foam by introducing air bubbles into an aqueous body comprising the chemical substance and collecting the foam comprising the chemical substance on a resulting gas-liquid interface; and collapsing the collected foam to thereby recover the chemical substance. The method may further comprise adding solid material comprising a liquid-solid suspension into the aqueous body comprising the chemical substance and collecting the foam comprising the solid material that is trapped in the foam. An apparatus and system for recovering a chemical substance from an aqueous body are also described. The apparatus and system comprise one or more vessel dimensioned to house an aqueous body comprising the chemical substance; one or venturi to produce a foam; one or more pump; and a collection vessel.

### FIELD OF THE INVENTION

The present invention relates to a method, apparatus and system to remove a chemical substance from an aqueous body and produce a treated aqueous product, and a product that is concentrated with the chemical substance.

The present invention relates to a method, apparatus and system for recovering the chemical substance from an aqueous body by introducing air bubbles, and optionally solid materials, into the aqueous body and collecting the chemical substance on the gas-liquid interface and optionally the solid-liquid interface, when solid material is present; followed by collapsing the foam to collect a concentrated stream.

In particular, but not exclusively, the present invention relates to a method, apparatus and system for separating and concentrating a PFAS (per- and polyfluoroalkyl substances) from an aqueous body by foaming with the aid of one or more surfactants, and optionally one or both of using a venturi and a multistage foam fractionation column. Advantageously, the method, apparatus and system may produce a PFAS free aqueous product and a PFAS concentrate product that is suitable for destruction of the concentrated stream containing PFAS.

### BACKGROUND TO THE INVENTION

PFAS are per- and polyfluoroalkyl substances, a group of over 4000 chemicals. Some PFAS are very effective at resisting heat, stains, grease and water, making them useful chemicals for a range of applications. Because they are heat resistant and film-forming in water, some PFAS have also been used as very effective ingredients in fire-fighting foams.

The historical use of PFAS in fire-fighting foams has resulted in increased levels being detected at sites like airports, defence bases, and other sites where fire-fighting training has been conducted, or where fire suppression systems are installed for extinguishing liquid-fuel fires. Its use in other applications such as waterproofing and fire retardants in fabric, among others, has resulted in increased environmental levels of PFAS being found near some industrial areas, effluent outfalls, landfill sites and landfill leachate. Unfortunately, the properties that make some PFAS useful in many industrial applications also make them problematic in the environment. The PFAS of greatest concern are mobile in water, which means they travel long distances from their source-point; they do not fully break down naturally in the environment; and are toxic to a range of animals.

The traditional approach to treatment of PFAS from water streams and effluents has been to remove PFAS from the aqueous stream by adsorption onto activated carbon or resins. While this process removes the PFAS from the aqueous stream, it creates a PFAS contaminated solid waste that itself requires treatment and disposal. Treatment of PFAS in activated carbon wastes is problematic and expensive, as the PFAS is only present in the waste in low concentrations.

There remains a need for methods, apparatus and systems to remove chemical substances from aqueous bodies.

The reference to any prior art in this specification is not, and should not be taken as, an acknowledgement or any form of suggestion that the prior art forms part of the common general knowledge.

### SUMMARY OF THE INVENTION

The present invention is directed to a method, apparatus and system to remove a chemical substance from an aqueous body and produce a treated aqueous product, and a product that is concentrated with the chemical substance. In a particular embodiment, the chemical substance comprises a PFAS.

In a broad form the invention relates to a method, apparatus and system for recovering the chemical substance from an aqueous body by introducing air bubbles, and optionally solid materials, into the aqueous body and collecting the chemical substance on a resulting gas-liquid interface and optionally the solid-liquid interface, when solid material is present; followed by collapsing the foam to collect a concentrated stream. The solid material may be trapped into the foam such that when the foam is collecting a concentrated stream of chemical substance and solid materials results.

In another broad form the present invention relates to a method, apparatus and system for separating and concentrating a PFAS from an aqueous body by foaming with the aid of one or more surfactants, and optionally one or both of: using an air water venturi; and a multistage foam fractionation column.

In yet another broad form the present invention relates to a method, apparatus and system for separating and concentrating a PFAS with high as well as low surface activity from an aqueous body by dosing solid material into the aqueous body which captures the PFAS on the solid surface or pores and removing the solid substance by foaming with the aid of one or more surfactants, and optionally one or both of: using a venturi; and a multistage foam fractionation column. The PFAS with low surface activity are usually short chain PFAS that has carbon chain length of 6 or less. The venturi may be a fluid venturi such as an air water venturi.

In one aspect, although it need not be the only or indeed the broadest form, the invention provides a method for recovering a chemical substance from an aqueous body, the method comprising:
producing a foam by introducing air bubbles into an aqueous body comprising the chemical substance and collecting the foam comprising the chemical substance on a resulting gas-liquid interface; and
collapsing the collected foam to thereby recover the chemical substance.

In one embodiment of the first aspect, the method further comprises:
adding solid material comprising a liquid-solid suspension into the aqueous body comprising the chemical substance; and
collecting the foam comprising the solid material that is trapped in the foam.

In a second aspect the invention provides an apparatus for recovering a chemical substance from an aqueous body, the apparatus comprising:
one or more vessel dimensioned to house an aqueous body comprising the chemical substance;
one or venturi to produce a foam by introducing air bubbles into the aqueous body housed in each of the one or more vessel;
one or more pump to drive the aqueous body or a portion thereof, and
a collection vessel to collect the foam comprising the chemical substance collected on a resulting gas-liquid interface.

In a third aspect the invention provides a system for recovering a chemical substance from an aqueous body, the apparatus comprising:
one or more vessel dimensioned for housing an aqueous body comprising the chemical substance;
one or venturi for producing a foam by introducing air bubbles into the aqueous body housed in each of the one or more vessel;
one or more pump for driving the aqueous body or a portion thereof; and
a collection vessel for collecting the foam comprising the chemical substance collected on a resulting gas-liquid interface.

In one embodiment of the second or third aspect, the apparatus further comprises one or more pump to feed the aqueous suspension of solid material into the vessel.

According to any one of the above aspects, the introduction may be repeated in a multiple stages.

In another embodiment according to any one of the above aspects, the foaming may comprise one or more surfactants, and optionally one or both of: using an air water venturi; and a multistage foam fractionation column.

In yet another embodiment, the solid material is fed into the vessel in a suspension where the chemical substance is trapped on the solid surface and its pores. The solid material may be suitable for trapping chemical substances that have low surface activity as well as high surface activity.

The addition of solid may remove short chain PFAS.

Advantageously, the invention provides a foam-fractionation process wherein air is introduced in the form of bubbles into the aqueous stream as the aqueous solution is continually recirculated into the individual vessel via a pump and the mixture of air and aqueous liquid is fed into the vessel, wherein the air bubbles rise upward towards the liquid surface and produces a foam layer. This foam layer has higher concentration of chemical substance in comparison to the concentration of the chemical substance in the aqueous solution. This foam layer may also capture solid materials that are fed into the vessel, optionally a majority of this solid material may be captured.

According to any one of the above aspects, the introduction of air in a form of bubbles into the aqueous stream may be achieved using one or more venturi. The polluted aqueous solution may be continually recirculated into the vessel via a pump and through the venturi wherein the mixture of air and aqueous solution may be introduced into the vessel in the form of small bubbles which rise towards the liquid to the surface. The shear force created by flowing liquid in the venturi may create micro bubbles in the liquid.

According to any one of the above aspects, any number of venturis may be comprised such as, 1; 2; 3; 4; 5; 6; 7; 8; 9 or 10 or more than 10. The one or more venturi may introduce air into the recirculating liquid from and back to the vessel. The liquid from the vessel may be drawn into the pump and fed into a liquid distributer which may distributes the liquid flow into multiple branches that feeds back to the vessel. Each branch may be equipped with one or more venturi.

The foam at the surface of the liquid may be extracted from the vessel and may be fed into the prior foam fractionation vessel and the liquid may be extracted from the vessel and is fed to the next foam-fractionation vessel.

According to any one of the above aspects, the solid material may be fed to one or multiple vessels in the foam-fractionation process. The solid material may be trapped into the foam at the surface of the liquid which is extracted from the vessel and may be fed into the prior foam fractionation vessel which permits the solid material to capture more chemical substances.

Advantageously, in one embodiment of any one of the above aspects, a counter current and multi-stage foam fractionation process is comprised. The foam may be extracted and transferred to prior stages while the liquid is collected and transferred to the next stages. The extracted foam may comprise the solid material and chemical substance. The chemical substance present in the foam may be either directly captured at the gas-liquid interface of the foam or trapped on the solids surface present in the foam or a combination of both.

According to any one of the above aspects, flow of liquid to the next vessel in the multistage is controlled by a flow control valve to maintain a fixed liquid level in a given vessel.

According to any one of the above aspects, the foam may be mixed with additional air before feeding into the prior section to maintain the desired liquid/air ratio in the venturi.

According to any one of the above aspects, a desired liquid to air ratio in the venturi may be the range of 4.0 to 1.5.

According to any one of the above aspects, the foam from the vessel “n” may be extracted and transferred into the vessel “n−1” with the help of the negative pressure created by the venturis installed in the vessel “n−1”. The suction lift created by the venturis may extract the foam from the vessel “n” together with extra air and may push it into the aqueous stream and subsequently into the vessel “n−1”.

According to any one of the above aspects, the process of mixing the foam into the prior vessel, may increase the concentration of chemical substance in the aqueous solution of the prior vessel. The increase in the concentration of chemical substance in the prior vessel further may increases the concentration of chemical substance of foam in the prior vessel.

According to any one of the above aspects, the process of mixing the foam containing solid material into the prior vessel, may increase the amount of chemical substance captured on the solid material and may increase the concentration of chemical substance in the solid material.

According to any one of the above aspects, the process may be operated with or without the addition of solid material to the aqueous solution.

In another embodiment of any one of the above aspects, the concentration of the chemical substance may reduce in the aqueous solution of stages n, n+1, n+2 . . . and the concentration of chemical substances increases in the foam of stages n, n−1, n−2 and so on.

In yet another embodiment of any one of the above stages, the number of stages in the process may be between 1 to 12. The number of stages may be higher when there is a small residence time of the liquid in a given vessel. The residence time may be 5 to 20 minutes.

In still another embodiment of any one of the above aspects, the contaminated aqueous solution may be fed continuously to a first vessel and the treated aqueous solution may be removed from the last vessel.

In another embodiment of any one of the above aspects, the solid material is fed into the vessel as an aqueous suspension. The solid material may be fed into one tank or multiple tanks simultaneously. Preferably, the solid material is fed to the central tank in the series of tanks. More preferably, the solid material is fed into the second to last tank in the series.

In still another embodiment of any one of the above aspects, the solid material is a hydrophobic material with small particle size that does not dissolve in the aqueous body. The solid material may be activated carbon powder. The solid material may be anionic resin powder. The solid material may be any material that can capture chemical substances on their surface or into their pores. The small particle size may be between 0.1 and 100 m.

In yet another embodiment of any one of the above aspects, the chemical substance may be PFAS or other surface active chemicals that can partition from liquid to the air/liquid interface.

In another embodiment of any one of the above aspects, the number of stages required for separating PFAS with varying length is different, with long chain PFAS getting separated in fewer stages while the number of stages required for complete separation increases as the chain length decreases. For example, PFOS and other long chain PFAS may be removed in the least amount of stages, while PFOA removal requires more stage then the former and PFHxA removal needs further more stages. Thus the chemicals may be fractionated with the various stages.

In yet another embodiment of any one of the above aspects, the chemicals which are not surface active may also be removed by binding them with surface active chemicals and/or solid materials.

In still another embodiment of any one of the above aspects, small chain PFAS which has low surface activity can may be removed by addition of high surface active chemicals which bind with the low surface active chemicals and facilitate the removal by partitioning it onto the liquid/air interphase and/or by being captured by the solid materials and facilitates the removal by trapping the solid materials into the foam.

In yet another embodiment of any one of the above aspects, one or more additional chemical may be added into the vessel to reduce the surface tension of aqueous solution which helps to reduce the size of air bubbles and also increases the stability of foam on the liquid surface that facilitates the extraction.

In yet another embodiment of any one of the above aspects the additional chemical may comprise one or more surfactant such as, a surfactant of cationic group, anionic group, zwitterionic group or non-ionic group.

In yet another embodiment of any one of the above aspects the solid material is be suspended into the surfactant chemicals. Both the suspended solid material and surfactant chemical can be added together.

In yet another embodiment of any one of the above aspects the dosing rate of surfactant into the aqueous solution to various tanks may be equal or unequal. The dosing rate of surfactant into the individual vessel may be controlled by a flow controller.

In yet another embodiment of any one of the above aspects any turbulence created in the vessel due to introduction of air bubbles may help to mix the surfactant into the aqueous solution.

In yet another embodiment of any one of the above aspects any turbulence created in the vessel due to introduction of air bubbles may help to suspend and distribute the solid material into the aqueous solution.

In yet another embodiment of any one of the above aspects, the one or more surfactant and/or solid material may also be separated from the liquid and into the foam layer. Thus the concentration of the one or more surfactant in the aqueous solution may decreases from tank n, n+1, n+2 and so on.

In yet another embodiment of any one of the above aspects, the foam generated by introducing air into the vessel may be enriched in chemical which is being separated from the liquid. This foam may be extracted from the surface of the liquid with a conical suction cup. The conical cup may occupy 25% to 75% of the liquid surface area.

In yet another embodiment of any one of the above aspects, the foam may be extracted by a positive suction created in the suction cup. The positive suction in the suction cup of the first vessel may be achieved by a suction pump, while the positive suction in the suction cup of the remaining vessels may be achieved with the venturi's of the previous vessels.

In yet another embodiment of any one of the above aspects, the suction cup of vessel n+1 may be connected to a main header which branches out into small lines and may be subsequently connected to the gas inlet of the venturis.

In yet another embodiment of any one of the above aspects, a mass flow rate of foamate collection from vessel 1 is 100 to 1000 times lower than the mass flowrate of contaminated liquid flow into the vessel.

In yet another embodiment of any one of the above aspects, a mass flowrate of foamate collection may be controlled by the position of the suction cup above the liquid surface. The position of the suction cup may be changed as the liquid flow-rate in the vessel is varied.

In yet another embodiment of any one of the above aspects, foamate may be collected from a first vessel may be collapsed into liquid and resent into another foam-fractionation vessel for further concentration.

In yet another embodiment of any one of the above aspects, the foamate collected from a first vessel may be filtered to remove and recover the solid material.

In yet another embodiment of any one of the above aspects, each of the one or more vessel may comprise a cylindrical vessel with a feed inlet and a suction cup located at a pre-specified position just above the liquid surface. The location of the suction cup may be 10 to 50 cm above the liquid surface.

In yet another embodiment of any one of the above aspects, a header pipe may be comprised to distribute the aqueous fluid. The header pipe may comprise one or more small pipes branching out from it and enters into the vessel around the circumference.

In yet another embodiment of any one of the above aspects, the foam extracting may comprise an inverted conical device, also called a suction cup, comprising a wide mouth positioned near the foam layer at a fixed height above the liquid surface and a narrower tail is connected to a header from which multiple pipes are branching out. These pipes are connected to the suction inlet of venturis of the prior tank.

The suction cup may be placed at a fixed height above the liquid surface. The height of the apparatus may determine the amount of foamate removed along with the foam. The apparatus that is placed well above the liquid surfaces, extracts a relatively dry foam as majority of the trapped liquid drains back into the vessel. The apparatus that is placed close to the liquid surface extracts a wet foam since it contains significant amount of entrained liquid from the aqueous solution.

According to any one of the above aspects, the treatment process can be used for clean water containing the chemical substance or for dirty water that has various co-contaminants. The dirty water may be any readily available water source that is not subjected to treatment process such as, purification.

Further aspects and/or features of the present invention will become apparent from the following detailed description.

### BRIEF DESCRIPTION OF THE DRAWINGS

In order that the invention may be readily understood and put into practical effect, reference will now be made to embodiments of the present invention with reference to the accompanying drawings, wherein like reference numbers refer to identical elements. The drawings are provided by way of example only, wherein:

FIG. 1A shows a schematic diagram showing one embodiment of the arrangement of the apparatus of the invention;

FIG. 1B is schematic diagram showing another embodiment of the apparatus of the invention.

Skilled addressees will appreciate that elements in the drawings are illustrated for simplicity and clarity and have not necessarily been drawn to scale. For example, the relative dimensions of some elements in the drawings may be distorted to help improve understanding of embodiments of the present invention.

### DETAILED DESCRIPTION OF THE INVENTION

The present invention relates to a method, apparatus and system to remove a chemical substance from an aqueous body and produce a treated aqueous product, and a product that is concentrated with the chemical substance. In a particular embodiment, the chemical substance comprises a PFAS.

The present invention is ate least partly predicated on the unexpected discovery that the chemical substance may be recovered from an aqueous body by introducing air bubbles into the aqueous body and collecting the chemical substance on a resulting gas-liquid interface followed by collapsing the foam to collect a concentrated stream.

The discovery also includes the observation that the chemical substance may be captured by the solid substance that is added to the aqueous body and the solid substance may be then removed from the aqueous body by the foam.

In particular aspects, the invention contemplates a method, apparatus and system for separating and concentrating a PFAS from an aqueous body by foaming with the aid of one or more surfactants, and optionally one or both of: using an venturi, such as a fluid venturi, the fluid optionally comprising air and water; and a multistage foam fractionation column.

In one embodiment, the invention relates to the use of a continuous multi-stage, counter current flow, foam fractionation process in which the aqueous effluent can be treated by removing the chemical substance from the aqueous body by transferring it into the foam phase and/or by capturing the chemical substance from the aqueous body on to a solid material and then transferring the solid into the foam wherein the chemical substance is concentrated to a lower volume for easily destruction and disposal.

In a particular embodiment, the chemical substance may be a PFAS which are per and polyfluoroalkyl substances or one or more other surface active chemicals in combination with a PFAS or in absence of PFAS.

While the invention will be described with reference to PFAS, it is not so limited.

Per- and poly-fluoroalkyl substances (PFAS) are a group of synthetic compounds resistant to thermal, microbial and chemical degradation. The fluorinated carbon chain imparts desirable oleophobic and hydrophobic properties, resulting in the widespread use of PFAS in consumer and industrial products such as paper, leather, lubricants, cement, metal cleaners and floor polishes as well as its use in foam-based fire extinguishers. The PFAS examined in this study were PFOS, PFOA, PFHxS, perfluorobutanoic acid (PFBA), perfluorobutane sulphonic acid (PFBS) and 6:2 fluorotelomer sulphonate (6:2 FTS) found in the landfill leachates.

The chemical substance may be concentrated in the foam in each stage of a cascade and the foam may be transferred upstream, counter-current to the flow of the aqueous effluent. As is typical, the highest concentration of chemical substance in foam may be removed from the first stage. The concentration of chemical substance in the aqueous effluent is reduced in each successive stage in series along the cascade with essentially complete removal (chemical substance concentration below detectable limits) achieved in the final stage.

The foam may also contain solid material that contain one or more chemical substance. The solid material may be fed into the tank as a suspension using a pump.

The solid material containing the chemical substance may be collected into the foam in each stage of the cascade and the solid containing foam may be transferred upstream, counter-current to the flow of the aqueous effluent. Due to this, the solid material is able to capture more chemical substance in the new tank and hence the highest concentration of chemical substance is in the solid present in the first stage.

The multistage fractionation may be a two; three; four; five; six; seven; eight; nine;
ten; or ten or more stage fractionation.

The foam from the first stage may undergo one or more further steps of concentration in a separate foam treatment stage to obtain an ultra-concentrate. The ultra-concentrate may be disposed or sent for destruction.

The foam from the first stage may be filtered to remove the solid material for reuse. The filtered solid material may also be mixed with ultra-concentrate to create a suspension that may be disposed or sent for destruction.

In one embodiment, the invention resides in a method for removing chemical substance which may be PFAS from aqueous streams including the steps of:
treating an aqueous body in a multistage foam fractionation counter current flow cascade; and
creating a foam in which the PFAS collects and concentrates, optionally using a surfactant and air drawn from atmosphere.

To create the foam one or more air water venturis may be used at each stage of the multistage foam fractionation.

The method may further comprise separating the foam and aqueous body at each stage, whereby the aqueous body may flow to each successive stage in series, and the foam may be transferred counter current to the aqueous body to the next upstream stage.

The method may also further comprise transferring the foam containing concentrated PFAS to a final foam fractionation step whereby a final PFAS concentrate or ultra-concentrate suitable for thermal plasma destruction is obtained.

In one embodiment the treated aqueous body from the final stage may comprise a PFAS concentration below detectable limits, and the body may suitable for discharge or return to the source depending upon other environmental considerations. The number of stages may vary from a single stage to an unlimited number of stages depending upon the requirements for ultimate PFAS removal.

In another embodiment, the treated aqueous body from the final stage may contain solid material residue and the treated aqueous body may be filtered to remove and recover solid material for reuse.

To facilitate foam formation, a surface-active chemical (co-surfactant) may be added and the addition of co-surfactant may vary from zero to 10 mg per litre of aqueous stream.

The solid material may be mixed with the surfactant to create a suspension and the solid material and surfactant may be fed together into the vessel.

While air may be introduced into the aqueous body via various methods, in one example this can be achieved by continuously recirculating the liquid in the tank via venturi, which draws in air.

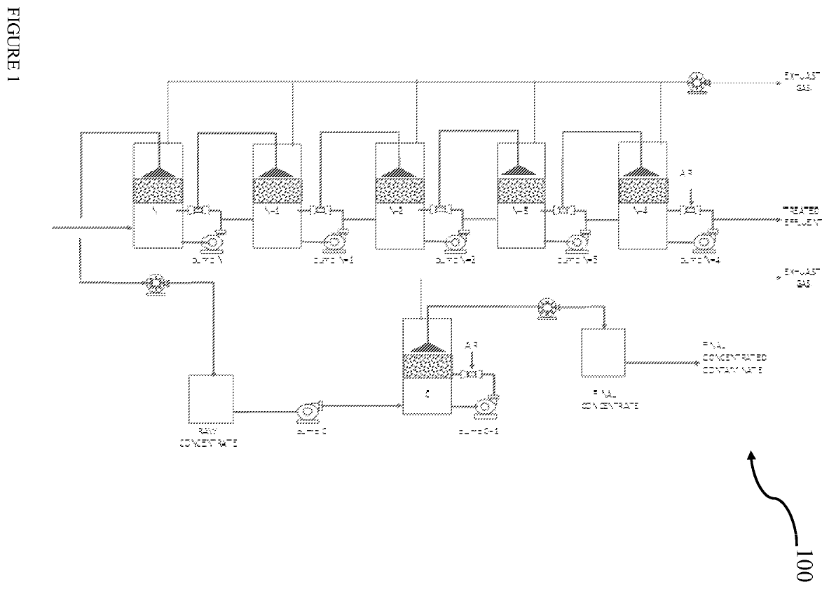

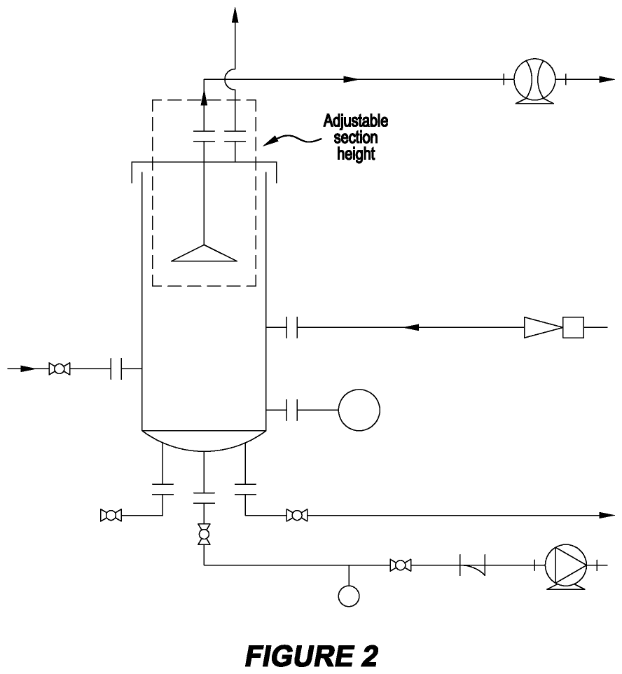

One embodiment of the process for removal and concentration of PFAS from aqueous body, according to one embodiment of the invention, is illustrated in FIG. 1A.

The contaminated aqueous body containing chemical substance, which can be PFAS, from a sources such as, groundwater, a landfill leachate, a surface acquirer, a waste-water plant or other any other water storage system or natural body is pumped into the pre-treatment stages which aim to remove any solid particulates, or to suppress the scale forming agents in the liquid.

The pre-treatment stages may also comprise pH adjustment by addition of mild acid or alkaline to facilitate the removal of ammonia and other ionic substances.

The pH adjustment may also be carried out to suppress scaling effects. In some embodiments, additional scale suppressing chemical are also added in the pre-treatment stage.

The pre-treated liquid may then be fed into the 1st treatment vessel (vessel N) as shown in process arrangement diagram in FIG. 1A using a flow control pump. The liquid is continually recirculated within this tank using the recirculation pump N that supplies the recirculated liquid into a tank via a venturi nozzle.

The air suction line of the venturi nozzle may be connected to the foam collection system of the downstream vessel in the sequence.

As the liquid flows through the venturi nozzle, the negative pressure created in the venturi extracts foam and air from the downstream vessel and mixes it with the liquid flowing through the venturi.

The mixture of foam, air and liquid is injected into the vessel, wherein the air forms tiny micro-bubbles and moves up the vessel to the liquid surface to generate foam layer.

Simultaneously, by mixing the PFAS enriched foam form downstream vessel with the liquid of the first vessel, increases the concentration of chemical substance in the 1st vessel. As the concentration of the chemical substance in the first vessel increases, the equilibrium concentration of the chemical substance in the foam also increases thus providing a foam emanating from the first vessel which may be highly enriched with PFAS.

A portion of liquid from the recirculation line, prior to the venturi, may then be fed to the second vessel in the sequence.

The same process may be repeated in all the subsequent vessel in the cascade. This the liquid moves in the downstream direction, while the foam moves counter currently in the upstream direction.

The contact pattern ensures that the liquid stream gets leaner with respect to the amount of chemical substance such as, PFAS, while the foam get enriched in the chemical substance such as PFAS, as both the stream crosses each treatment stage.

In one embodiment, the liquid residence time in each stage ranges between 5 and 20 mins to provide sufficient time for the chemical substance to transfer from the liquid phase to the foam phase. From the teaching herein a skilled person is readily able to select other suitable residence times.

The liquid residence time may depend on the total bubble flux and which can be changed by varying the liquid recirculation rate through the venturi.

The foam may then be extracted by a conical shaped foam collection devise placed in the foam chamber of the vessel that channels the collected foam into the venturi of the preceding vessel.

The foam residence time may depend on the height of the conical shaped foam collection device above the foam-liquid interface in the vessel.

A high foam residence time in the vessel may increase the internal reflux by permitting the drainage of the entrained liquid in the foam but at the same time cause some foam breakage. The typical foam residence time in the vessel may vary between 0.5 and 5 minutes.

A portion of air may be released in the vessel due to foam collapse. The released air may be extracted from the tank into a common extraction header line via an extraction fan E1 and exhausted into the environment.

In one embodiment, the exhausted air from the fan E1 is further treated by a carbon bed to filter to remove any contaminants in the exhaust air before releasing into the atmosphere.

The liquid level in the vessel may be controlled by the rate of liquid transferred from one vessel to the other via, for example, a flow controlled valve.

The vessel may be equipped with more than 1 venturis to increase the bubble flux in the vessel. There may be 2; 3; 4; 5; 6; 7; 8; 9; 10; or more than ten venturis. From the teaching herein, a skilled person is readily able to select an appropriate number of venturis.

In case of multiple venturi's in the vessel, the foam from the succeeding vessel may be equally distributed in the venturi lines by pressure balance in each lines.

The ratio of the rate of foamate collected from each vessel in the cascade to the liquid flow rate may range between 100 and 1000.

The aqueous solution of the co-surfactant chemical is dosed independently in each vessel via a peristatic pump. The dose rate of co-surfactant chemical is highest in the final tank and reduces in each up-stream vessel. The solid material may also be mixed with the co-surfactant chemical and dosed into the desired vessel.

In case of aqueous stream with low surface tension the addition of co-surfactant may be limited to just the final tank in the cascade or in other cases it may not be necessary at all.

In even the addition of co-surfactant is not required, the solid material may be suspended in water and fed into the desired vessel.

In a case where the co-surfactant is added in the vessel, the turbulence in the vessel that is created by the induced jet from the venturi is sufficient to perfectly mix the co-surfactant into the solution.

The foam from the first processing vessel may be extracted by a suction pump S-1 and sent to raw concentrate collection tank. The foam may be collapsed and then pumped to re-concentration stage in vessel C.

Air is introduced into vessel C as fine micro bubbles that is generated from the one or more venturi as the vessel liquid is recirculated though the venturi. The reconcentrated foam with high concentration of chemical substance, which can be PFAS, is generated in the vessel which is collected for final disposal or destruction of chemical substance.

In another embodiment, the re-concentration of the foam may be conducted in more than one stage.

The residence time of liquid in the re-concentration stage may be between 15 and 30 minutes. From the teaching herein a skilled person is readily able to select other suitable residence times.

The ratio of the rate of foamate collected from re-concentration stage to the liquid flow rate into the re-concentration vessel may range between 5 and 50.

The released air from the re-concentration vessel may be extracted from the tank into a common extraction header line via an extraction fan E1 and exhausted into the environment.

In one embodiment the exhausted air from the fan E1 is further treated by a carbon bed to filter to remove any contaminants in the exhaust air before releasing into the atmosphere.

FIG. 1B shows a schematic view of the foam fractionation vessel for separating the chemical substance from the aqueous solution.

The following non-limiting examples illustrate the invention. These examples should not be construed as limiting: the examples are included for the purposes of illustration only. The Examples will be understood to represent an exemplification of the invention.

### Example 1

The present inventors have conducted field trial for treatment of landfill leachates using the apparatus 100 described in the invention. In the example described, the treatment had 5 stages in the cascade and 1 stage in the re-concentration step. The chemical substance removed from the landfill was PFAS.

The co-surfactant used in this investigation was an anionic (sodium dodecyl sulphate (SDS)).

The liquid feed rate was 10 LPM (litres per minute).

The example of the removal efficiency of the PFAS species are shown in Table 1:

TABLE 1
Example removal efficiency at 10 LPM

| | Feed | | | | | Stage 5 | |
|---|---|---|---|---|---|---|---|
| | Conc | Stage 1 | Stage 2 | Stage 3 | Stage 4 | (product) | % |
| Specie | ppb | ppb | ppb | ppb | ppb | ppb | removed |
| PFBA | 0.646 | 0.676 | 0.666 | 0.702 | 0.616 | 0.622 | 3.7% |
| PFBS | 0.306 | 0.076 | 0.082 | 0.052 | 0.04 | 0.072 | 76.4% |
| PFHxS | 0.416 | n.d. | n.d. | n.d. | n.d. | n.d. | 100% |
| PFOA | 2.126 | n.d. | n.d. | n.d. | n.d. | n.d. | 100% |
| PFOS | 1.174 | n.d. | n.d. | n.d. | n.d. | n.d. | 100% |
| 6:2 FTS | n.d. | n.d. | n.d. | n.d. | n.d. | n.d. | — |

### Example 2

In another example, with the liquid rate of 15 LPM, the test results are as shown in Table 2.

TABLE 2

| | Feed | | | | | Stage 5 | |
|---|---|---|---|---|---|---|---|
| | Conc | Stage 1 | Stage 2 | Stage 3 | Stage 4 | (Product) | % |
| Specie | Ppb | ppb | ppb | ppb | ppb | ppb | removed |
| PFBA | 0.706 | 0.914 | 0.838 | 0.812 | 0.81 | 0.798 | 0% |
| PFBS | 0.062 | 0.106 | 0.09 | 0.094 | 0.092 | 0.042 | 32.25% |
| PFHxS | 0.358 | n.d. | n.d. | n.d. | n.d. | n.d. | 100% |
| PFOA | 1.086 | n.d. | n.d. | n.d. | n.d. | n.d. | 100% |
| PFOS | 1.106 | n.d. | n.d. | n.d. | n.d. | n.d. | 100% |
| 6:2 FTS | n.d. | n.d. | n.d. | n.d. | n.d. | n.d. | — |

### Example 3

In another example, with a commercial scale treatment liquid rate of 60 LPM, the test results are as shown in Table 3.

TABLE 3

| | Influ- | Efflu- | % |
|---|---|---|---|
| | ent | ent | re- |
| Species | (ppb) | (ppb) | moved |
| Perfluorobutanoic acid (PFBA) | 0.61 | 0.56 | 8% |
| Perfluoropentanoic acid (PFPeA) | 1.80 | 1.60 | 11% |
| Perfluorohexanoic acid (PFHxA) | 1.40 | 1.10 | 21% |
| Perfluoroheptanoic acid (PFHpA) | 0.44 | N.D. | 100% |
| Perfluorooctanoic acid (PFOA) | 0.41 | N.D. | 100% |
| Perfluorononanoic acid (PFNA) | 0.04 | N.D. | 100% |
| Perfluorodecanoic acid (PFDA) | N.D. | N.D. | — |
| Perfluoroundecanoic acid (PFUnDA) | N.D. | N.D. | — |
| Perfluorododecanoic acid (PFDoDA) | N.D. | N.D. | — |
| Perfluorotridecanoic acid (PFTrDA) | N.D. | N.D. | — |
| Perfluorotetradecanoic acid (PFTeDA) | N.D. | N.D. | — |
| Perfluorooctane sulfonamide (FOSA) | N.D. | N.D. | — |
| N-methylperfluoro-1-octane sulfonamide | N.D. | N.D. | — |
| (N-MeFOSA) | | | |
| N-Ethylperfluoro-1-octane sulfonamide | N.D. | N.D. | — |
| (N-EtFOSA) | | | |
| 2-(N-methylperfluoro-1-octane-sulfonamido)- | N.D. | N.D. | — |
| ethanol (N-MeFOSE) | | | |
| 2-(N-ethylperfluoro-1-octane-sulfonamido)- | N.D. | N.D. | — |
| ethanol (N-EtFOSE) | | | |
| N-ethyl-perfluorooctanesulfonamidoacetic | N.D. | N.D. | — |
| acid (N-EtFOSAA) | | | |
| N-methyl-perfluorooctanesulfonaimdoacetic | N.D. | N.D. | — |
| acid (N-MeFOSAA) | | | |
| Perfluoropropanesulfonic acid (PFPrS) | 0.10 | 0.11 | — |
| Perfluorobutanesulfonic acid (PFBS) | 0.48 | 0.42 | 13% |
| Perfluoropentanesulfonic acid (PFPeS) | 0.36 | 0.12 | 67% |
| Perfluorohexanesulfonic acid (PFHxS) | 1.30 | N.D. | 100% |
| Perlfuoroheptanesulfonic acid (PFHpS) | 0.07 | N.D. | 100% |
| Perfluorooctanesulfonic acid (PFOS) | 1.00 | N.D. | 100% |
| Perfluorononanesulfonic acid (PFNS) | N.D. | N.D. | — |
| Perfluordecanesulfonic acid (PFDS) | N.D. | N.D. | — |
| 1H.1H.2H.2H-perfluorohexanesulfonic acid | N.D. | N.D. | — |
| (4:2 FTSA) | | | |
| 1H.1H.2H.2H-perfluorooctanesulfonic acid | N.D. | N.D. | — |
| (6:2 FTSA) | | | |
| 1H.1H.2H.2H-perfluorodecanesulfonic acid | N.D. | N.D. | — |
| (8:2 FTSA) | | | |
| 1H.1H.2H.2H-perfluorododecanesulfonic acid | N.D. | N.D. | — |
| (10:2 FTSA) | | | |
| Sum (PFHxS + PFOS) | 2.30 | N.D. | 100% |
| Sum of enHealth PFAS (PFHxS + PFOS + | 2.71 | N.D. | 100% |
| PFOA) | | | |

Advantageously, the present invention provides a method, apparatus and a system of separating a chemical substance from an aqueous solution by multi-staged foam-fractionation process followed by collection of the concentrated substance.

In this specification, the terms “comprises”, “comprising” or similar terms are intended to mean a non-exclusive inclusion, such that an apparatus that comprises a list of elements does not include those elements solely, but may well include other elements not listed.

Throughout the specification the aim has been to describe the invention without limiting the invention to any one embodiment or specific collection of features. Persons skilled in the relevant art may realize variations from the specific embodiments that will nonetheless fall within the scope of the invention.

1-46. (canceled)

47: A counter current and multi-stage method for recovering a chemical substance from an aqueous body, the method comprising:
producing a foam by introducing air bubbles into the aqueous body comprising the chemical substance; and
collecting the foam comprising the chemical substance on a resulting gas-liquid interface wherein the collected foam is extracted from the vessel and is fed into a prior foam fractionation vessel and the liquid is extracted from a vessel and is fed to a next foam-fractionation vessel; and
collapsing the collected foam to thereby recover the chemical substance.

48: The method according to claim 47, further comprising:
adding solid material comprising a liquid-solid suspension into the aqueous body comprising the chemical substance; and
collecting the foam comprising the solid material that is trapped in the foam.

49: A counter current and multi-stage foam fractionation apparatus for recovering a chemical substance from an aqueous body, the apparatus comprising:
one or more vessel dimensioned to house the aqueous body comprising the chemical substance;
one or venturi to produce a foam by introducing air bubbles into the aqueous body housed in each of the one or more vessel;
one or more pump to drive the aqueous body or a portion thereof; and
a collection vessel to collect the foam comprising the chemical substance collected on a resulting gas-liquid interface wherein the collected foam is extracted from the collection vessel and is fed into a prior foam fractionation vessel and the liquid is extracted from the vessel and is fed to a next foam-fractionation vessel.

50: The apparatus of claim 49, further comprising one or more pump to feed an aqueous suspension of solid material into the vessel.

51: A counter current and multi-stage foam fractionation system for recovering a chemical substance from an aqueous body, the apparatus comprising:
one or more vessel dimensioned for housing the aqueous body comprising the chemical substance;
one or venturi for producing a foam by introducing air bubbles into the aqueous body housed in each of the one or more vessel;
one or more pump for driving the aqueous body or a portion thereof; and
a collection vessel for collecting the foam comprising the chemical substance collected on a resulting gas-liquid interface wherein the collected foam is extracted from the vessel and is fed into a prior foam fractionation vessel and the liquid is extracted from the vessel and is fed to a next foam-fractionation vessel.

52: The system of claim 51, further comprising one or more pump to feed an aqueous suspension of solid material into the vessel.

53: The apparatus according to claim 49, wherein the introduction is repeated in multiple stages.

54: The apparatus according to claim 49, wherein the foam comprises one or more surfactants, and optionally one or both of: using an air water venturi; and a multistage foam fractionation column.

55: The apparatus of claim 49, wherein the solid material is fed into the vessel in a suspension where the chemical substance is trapped on the solid surface and its pores.

56: The apparatus of claim 49, wherein the solid material is fed to the one or multiple vessels in the foam-fractionation process.

57: The apparatus according to claim 49, wherein flow of liquid to the next vessel in the multistage is controlled by a flow control valve to maintain a fixed liquid level in a given vessel.

58: The apparatus according to claim 49, wherein the foam is mixed with additional air before feeding into the prior foam fractionation vessel to maintain the desired liquid/air ratio in the venturi.

59: The apparatus according to claim 49, wherein a desired liquid to air ratio in the venturi is the range of 4.0 to 1.5.

60: The apparatus according to claim 49, wherein the foam from one or more vessel “n” is extracted and transferred into one or more vessel “n−1” with the help of negative pressure created by the one or more venturi installed in the one or more vessel “n−1”.

61: The apparatus according to claim 49, wherein a process of mixing the foam into the prior vessel, increases a concentration of chemical substance in the aqueous solution of the prior vessel.

62: The apparatus according to claim 49, wherein the concentration of the chemical substance reduces in the aqueous solution of stages n, n+1, n+2 . . . and the concentration of chemical substances increases in the foam of stages n, n−1, n−2 and so on.

63: The apparatus according to claim 49, wherein the chemical substance is PFAS or other surface active chemicals that can partition from liquid to the air/liquid interface.

64: The apparatus according to claim 49, wherein one or more additional chemical is added into the vessel to reduce surface tension of aqueous solution which helps to reduce a size of air bubbles and also increases stability of foam on a liquid surface that facilitates extraction.

65: The apparatus according to claim 49, wherein a suction cup or inverted conical device of vessel n+1 is connected to a main header which branches out into small lines and may be subsequently connected to the gas inlet of the venturis.

66: The apparatus according to claim 49, wherein each of the one or more vessel comprises a cylindrical vessel with a feed inlet and a suction cup or inverted conical device located at a pre-specified position just above the liquid surface.
